(19) United States
(12) Patent Application Publication
(10) Pub. No.: US 2023/0031721 A1
(43) Pub. Date: Feb. 2, 2023

(54) MEASURING DRILLING PARAMETERS OF A DRILLING OPERATION

(71) Applicant: GLOBALTECH CORPORATION PTY LTD, Forrestfield (AU)

(72) Inventors: Gordon Stewart, Forrestfield (AU); Raymond Hill, Forrestfield (AU); Brett Wilkinson, Forrestfield (AU)

(21) Appl. No.: 17/788,512

(22) PCT Filed: Dec. 24, 2020
(86) PCT No.: PCT/AU2020/051441

§ 371 Date: Jun. 23, 2022

(30) Foreign Application Priority Data
Dec. 24, 2019 (AU) 2019904945

(51) Int. Cl. E21B 47/12; E21B 47/06; G01F 1/74

(52) U.S. Cl. CPC E21B 47/12; E21B 47/06; G01F 1/74

(57) ABSTRACT

Described is apparatus housing an instrumented device and an inner tube providing a fluid flow path therethrough. A strain gauge is on the outer surface of the inner tube. Bulkhead(s) transfers forces from an external housing to the inner tube to be detected by the strain gauge. Flow sensors measure fluid flow velocity and/or fluid flow volume rate. Pressure sensors sense pressure differential between an inlet side and an outlet side of the apparatus. Sensors provide for measurement of RPM, WOB, azimuth and rate of penetration. Communication means (such as a Wi Fi transceiver) and/or GPS device can communicate through EM transparent windows. The apparatus is used aboveground axially in-line in a drill string.

### FIELD OF THE INVENTION

The present invention relates to an apparatus and a method for sensing/measuring parameters relating to a drilling operation, such as for mineral exploration.

### BACKGROUND TO THE INVENTION

Drilling is often conducted as a part of an exploration program to obtain detailed information about the rocks below the ground surface, such as rock type(s), strata structure, strata direction and presence of mineral/metal ores.

The drilling method and size of the drilling rig used depends on the type of rock and information sought.

A number of drilling techniques are used in the mineral exploration industry. Some of these are air-core drilling, reverse-circulation (RC) drilling, diamond core drilling, rotary mud drilling and sonic drilling.

Air-core drilling employs hardened steel or tungsten blades to bore a hole into unconsolidated ground. The drill bit generally has three blades. Drill rods are hollow and are fitted with an inner tube within the outer barrel, similar to the rods used for reverse circulation drilling (described below).

Drill cuttings are recovered by injection of compressed air into the annulus between the inner tube and the inside wall of the drill rod, and are lifted to the surface by upward air flow through the inner tube. Samples are then passed through a sample hose into a cyclone where they are collected in buckets or bags.

Reverse Circulation (RC) drilling is similar to air core drilling, in that the drill cuttings are returned to surface inside the rods.

The drilling mechanism is a pneumatic reciprocating piston known as a hammer driving a tungsten-steel drill bit. RC drilling generally produces dry rock chips, depending on the operating conditions, as the expanding air exhausted from the hammer displaces and lifts any water present to the surface via the annulus between the drill string and the hole, whilst the cuttings are directed up the relatively water free inner pipe to the sampling system at the surface.

Reasonably large air compressors are used to power the pneumatic hammer, with higher volumes of air and greater pressures being required as borehole depth increases.

Diamond core drilling differs from other drilling methods used in mineral exploration in that a solid core of rock (generally 27 to 85 mm in diameter, but can be up to 200 mm), rather than cuttings, is extracted from depth. This method uses a rapidly rotating drill bit that relies on water and drilling fluids, pumped from an in-ground sump or above ground tanks, to cool and lubricate the drill bit during operation.

As the drill rods advance, the cylinder of remaining rock gradually becomes enveloped by the drill rods. Ground up rock material is transported to the surface by the returning drilling fluids and is separated from the fluids, typically in drill sumps or small ponds. Sometimes the separation is achieved mechanically using a series of screens, cyclones and filter pads, rather than simply relying on gravity as is the case with the aforementioned.

Rotary mud drilling method generally is used for drilling through soft to medium hardness formations especially in the search for coal and other hydrocarbons. The rotary bit is normally comprised of 3 roller cones (tri-cones) arranged such that they rotate about their own axis of symmetry as well as the drill string axis upon rotation of the latter. This combined with a high drill string down force produces a crushing/grinding/dragging action at the bottom of the hole to thereby produce rock cuttings. A special mix of clay and water is forced down the drill hole whilst rotating the drill string, the purpose of which is to flush the cuttings from the bottom of the hole and convey them to the surface via the annular cavity between the drill string and the hole.

Drilling equipment generally comprises a drill bit attached to a drill string, a drive system and a mast to support the drill string. There may be a pneumatic hammer to reciprocate the drill bit in order to strike the rock with force. The drill string is rotated by the drive system, such as a top drive system, and pushed downwards (or pulled inwards). The drill bit is driven down the hole. Drilling fluid, such as compressed air or mud, is pumped through the drill string and dispensed at the drill bit. As the drill bit breaks the rock, the drill cuttings are flushed out of the hole by the pressurised fluid.

Monitoring drilling parameters is an important aspect of drilling operation. The performance and progress of the drilling operation are controllable by monitoring the parameters.

Such monitoring can be limited to (i) pressure sensors measuring fluid pressure mobilised in hydraulic cylinders (providing axial thrust on the drill string) and in hydraulic motor (rotating the drill string), and (ii) simple displacement sensor to measure rate of penetration. Uncertainties associated to those measurements are often large and can lead to erroneous estimate of down-hole drilling parameters (in particular force mobilised at the bit-rock interface).

Improving the precision and/or resolution of drilling related measurement is very valuable to: (i) reduce uncertainties during the monitoring of drilling operations; (ii) report and compare drilling performance with scientific objectivity; (iii) optimise drilling performance in real time, but also the design of drilling procedure and strategy; and (iv) develop drilling simulation and to train drilling personnel.

Improving quality of measurement with minimum, if any, need for retro-fitting rigs is an important rationale of at least one form of the present invention.

Therefore, there is a desire to provide improved capability for measurement of at least one drilling parameter. Such improvement helps to inform drilling personnel of progress, efficiency and leads to the avoidance of failures. This can not only reduce overall costs and speed up drilling progress, but also reduces the need for drillers to apply subjective judgement with respect to drilling and the drilling equipment.

### SUMMARY OF THE INVENTION

It is desirable of the present invention to provide an apparatus and/or method for measuring drilling parameters, such as for mineral exploration, which provides useful measurements downhole and/or at the surface over, or to enhance, practices currently in use.

There is wireline diamond coring/drilling and conventional coring/drilling. It will be appreciated that one or more forms of the present invention can be used with such coring/drilling operations. In conventional diamond core drilling the rods need to come out to get the core rather than using a wireline to pull up the core.

Diamond coring is method of drilling which requires less equipment compared to RC drilling. However, it can command a very high cost per metre rate, much higher than Reverse Circulation (RC) drilling. The reason for this is because it is slow with high costs such as core bits, drilling additives, fuel and labour.

Coring is a very old drilling method and the drilling parameters are much different to those used in RC and conventional drilling. A high rpm, typically 300 to 1200 rpm, is required. Weight on the bit and rate of penetration need to be constant to ensure the core is not washed away. In hard rock formations not enough weight risks polishing the bit, while too much weight can cause the bit to burn. This method therefore requires skill and knowledge of which type of bit to use.

One or more forms of the present invention can be provided to monitor productivity and performance or as a way to provide a feed to operate a drill rig automatically or remotely. For example, one or more embodiments can be provided in a drill string on a dumb rig (hydraulic fluid controls) and use the apparatus to feed direct measurements to electronic controls that could operate the rig more safely, remotely or automatically.

In directional drilling (underground turbine to change direction) there is no rotation but there is flow to drive a downhole turbine. One or more embodiments of the present invention can be used to measure forces and flow without rotation.

An aspect of the present invention provides an apparatus for measuring at least one parameter of a drilling operation, the apparatus including a housing, a conduit providing a fluid flow path through the housing, the conduit being connected to the housing at at least two spaced locations, and a device including electronics and at least one sensor, the at least one sensor being provided within the housing.

Preferably at least one said sensor may be provided on the conduit. More preferably the at least one sensor may be provided on a wall of the conduit, which may be an external wall of the conduit within the housing.

Preferably, at least one said sensor may be provided on an inside wall (such as an internal face of a side wall) of the housing. The side wall may be an external wall of the housing, such that the at least one sensor is on the internal face within the housing of the external wall of that housing.

Alternatively, or in addition, at least one said sensor may be provided on an external face of side wall of the housing, such as, for example, being mounted, attached, connected or bonded to an external face of a side wall of the housing.

The at least one sensor may communicate wirelessly through the respective wall to electronics within the housing.

Preferably the at least one sensor includes at least one strain gauge, preferably multiple strain gauges, mounted to a surface of the conduit through the housing.

Preferably, the conduit includes an inner tube extending through the housing.

The at least one strain gauge may be bonded to an outside surface of the inner tube.

At least one strain gauge may be bonded to an inside surface of an outer tube.

The at least one strain gauge assembly can be connected to a carrier and subsequently bonded on inside wall of housing. In such an embodiment, strain is directly measured within the main load bearing member (rather than a secondary member). Also, the strain is therefore measured at a larger radius, and so for torsional readings, improved resolution is achieved than when measuring on a smaller diameter inner shaft as previously shown. This arrangement can avoid ‘keying’ the inner shaft at both ends, simplifying manufacture. It enables one end of the inner tube to ‘float’ and simplifies the mounting of the electronics module, as it is no longer mounted to a significantly stressed member. In essence, there are advantages to each of these approaches, and either system is a viable solution. At least one strain gauge may be bonded to, or otherwise mounted to (such as by a releasable attachment means, such as a clamp or band etc.) an outside surface of the outer tube.

Because of the external access to the strain gauge or each strain gauge on the surface of the conduit, each strain gauge can be accurately located and pressure applied to ensure intimate contact with the conduit.

It will be appreciated that such mounting of the strain gauge(s) externally of the conduit enables direct access to the strain gauge(s), such as for inspection and replacement if required.

Preferably, the conduit, such as the inner tube, includes a stressed portion. The stressed portion can be prestressed, such that the strain gauges can be calibrated with respect to the stressed member for more accurate strain gauge sensing.

The conduit, such as the inner tube, may include a thinner walled section than one or more thicker walled sections with respect thereto. The stressed portion can be prestressed, such that the strain gauges can be calibrated with respect to the stressed member for more accurate strain gauge sensing.

The at least one strain gauge need not require a carrier used to locate the strain gauge(s) to the conduit. For example, since the at least one strain gauge need not be bonded to a stressed said housing within a blind cavity.

Furthermore, the at least one strain gauge need not require deployment of an air bag to apply uniform pressure during the bonding process within the blind cavity when bonding the at least one strain gauge to the conduit, such as at a said stressed/thinner walled section/portion.

The apparatus may include a power generator to generate power to power electronics of the apparatus and/or to charge at least one charge storage device, such as at least one battery and/or at least one capacitor (e.g. super-capacitor, ultra-capacitor).

The power generator may operate by harnessing kinetic energy from fluid flow through the device, such as through the inner tube.

Flow of fluid through the apparatus may be detected by flow sensing.

Flow sensing may be by at least one flow sensor arrangement e.g. for sensing pressure differential through or across the apparatus, such as by detecting inlet and outlet pressure differential.

Pressure differential may be by the Bernoulli effect of fluid flow through the flow path provided, at least in part, through the conduit.

The apparatus may include an energy harvester for energy harvesting from vibration created by drilling and/or fluid flow, such as through the apparatus.

Alternatively, or in addition, energy harvesting may be by harnessing rotation, such as by rotation of a turbine operated by the fluid flow e.g. through the apparatus.

Wall thickness of the conduit within the housing can be provided to ensure desired/correct parameters are detected, such as force and/or torque.

The apparatus may include at least one pressure sensor.

The at least one pressure sensor may be used to sense a pressure impulse, such as a pressure spike.

Such a pressure impulse may arise due to landing of a tool downhole, such as an inner core tube for use in obtaining a core sample. The pressure impulse may be detected at the device.

Confirmation of the landing by such impulse detection may be provided to an operator, such as by a confirmation light, audible alert, communication to a mobile device (e.g. mobile phone, tablet, laptop etc.) or combination of any two or more thereof.

Alternatively, or in addition, a said pressure impulse may be used to remotely detect a downhole event or signal, such as receiving a signal from a fluid/mud pulser further downhole or further uphole with respect to the apparatus, or any electronic signal.

Strain gauge location on the outer surface of the conduit provides for an independent transducer that can be built, tested and calibrated prior to fitment within a housing, such as the outer tube. That is, the device may be assembled before mounting into the housing.

At least one said strain gauge assembly may be provided as a single strain gauge, e.g. incorporating compensation and avoiding the need for multiple, spaced strain gauges for compensation.

A said strain gage assembly can be provided connected to carrier and subsequently bonded on inside wall of the housing or to the outer wall of the inner tube, or a combination thereof.

A single strain gauge provides temperature compensation because all resistances are subject to the same temperature and the associated Wheatstone bridge of the strain gauge balances.

Another advantage of the single strain gauge is the detection of bending of the drill string on one side (lateral bending). That bending and associated detection by the apparatus is a measure of how well aligned the drill string is compared to centre line of the bore/drill hole. It will be appreciated that this is a sinusoidal measurement that can be mathematically analysed to extract information such as for diagnostics, fatigue and forces such as vibration, drilling performance and/or accuracy of the drill string alignment with the hole. The more lateral bending is avoided or compensated for, the more efficient the rock drilling. Drill bits last longer and there is less drill rig downtime and less maintenance.

Also, when a single strain gauge is provided as a single sensor (not split), the Wheatstone bridge is not split with two resistors one side and two the other. If the drill rods are heated, such as by the sun one side, the temperature will be compensated, and an accurate expansion of the steel will be measured and not the false measurement because one side of the drill string being hotter and the other side being cooler, resulting in better measurement accuracy.

The at least one strain gauge may be provided as diametrically opposed strain gauges. This configuration enables the effects of a bending moment on the sub/upper drill pipe to be cancelled via the wiring arrangement, so that only pure torsional and axial strain are measured. This is desirable for many drive shaft configurations where strain gauges are used, and is the traditional approach used when processing signals with analogue circuits. A drawback of this is the need to duplicate the gauges, and need to be precisely positioned to ensure they are diametrically opposite, otherwise errors are introduced. This impacts production cost both in terms of component and assembly cost and affects calibration and diagnostics. Therefore, an alternative arrangement has been developed using a single gauge arrangement. With this arrangement, as well as measuring the axial load, if there is any bending stress present as the drill rod rotates the strain gages will also measure the cyclic strain due to the bending. This will result in a sinusoidal signal superimposed on that arising from the axial load.

With the use of digital processing, the sinusoidal component can be filtered and used to measure the bending moment and enable the driller to determine that the drill head is not correctly aligned. This helps minimise wear and tear on rods, threads, head bearings etc, thereby improving operational efficiency and reducing cost.

The sinusoidal signal can be separated from the total signal so that the remaining strain signal(s) is/are due to the axial load only, which is then used to deduce the weight on the bit, and important drilling parameter that traditionally has been difficult to measure with any accuracy. Hence using the single gauge arrangement more information about the drill string is obtained with reduced strain gauge hardware, at lower cost.

The conduit can be directly or indirectly connected to the housing e.g. internally of the housing and preferably towards or at each end of the apparatus, and therefore share both axial load and torque with the outer housing.

Proportional share of axial load and torque can be dependent on the relative stiffness of the components (conduit and housing). With a parallel arrangement (conduit extending coaxially within the housing), the two force sharing elements (conduit and housing) undergo similar/identical axial and angular displacement.

About 5% to 30%, preferably 10% to 25%, and more preferably 20%, of the axial load may be detected ('seen) by a load cell (e.g. by the strain gauge(s) on the conduit) of the device due to cross sectional area ratio present.

Preferably a wall of the conduit to which the at least one strain gauge is located may be of a lesser thickness than adjacent wall thickness of the conduit. This may provide a smaller mean diameter of conduit.

Since torsional stiffness is proportional to the fourth power of the diameter, approximately up to 5% of torque, preferably up to 3%, and more preferably up to 2% of torque, may be detected at the at least one strain gauge (such as by a said load cell). The housing may take a majority proportion of axial and/or torsional load, preferably providing a safety factor for a given application, whilst ensuring that the at least one strain gauge receives sufficient proportion of axial load and torque for efficient sensing.

Preferably, when under maximum combined load the strain gauge(s) will detect/sense in the order of 1,000 to 10,000 microstrain, preferably 2,000 to 6,000 microstrain, more preferably 2,500 to 4,000 microstrain and yet more preferably approximately 3,000 microstrain.

A lower strain value may result in a loss of measurement resolution, and a higher strain value at maximum load may result eventually in fatigue of the strain gauge(s), whilst significantly higher strain can result in plastic deformation of the gauge or damage to the bond between the gauge and substrate and lead to a permanent offset in the strain reading and loss of calibration.

The conduit is arranged and configured such that, for given load deflections applied to the outer housing, adequate axial and torsional strains are produced and detected by the strain gauges. This may be achieved by configuration of lengthwise sectional properties of the conduit.

When considering the conduit configuration for the at least one strain gauge location (e.g. stiffness properties of the inner tube at the location for the at least one strain gauge), one or more embodiments of the present invention employs the following characteristics:
the minimum recommended bore for the fluid flow (such as drilling mud) through the conduit;
space available within the housing to package electronics and charge storage devices;
conduit wall thickness required to withstand mud hydraulic pressure;
sectional length/rigidity to avoid buckling during assembly/removal/operation of the device with respect to the housing;
need for suitable detectable strain levels to obtain required measurement resolution & accuracy;
transitions between sections to prevent creation of excessive stress raisers;
desire for uniform properties adjacent to strain gauges to produce reasonable linearity

Optimization of strain for measurement resolution/accuracy may be controlled by:
Adjustment lengthwise of the conduit, such as an inner tube, polar moment of inertia
Setting of the relative length of individual uniform sections along the conduit
Gradual changes of sectional properties at diameter transitions
Selection of strain gauges with suitable gauge lengths and gauge factors

In this manner an inner tube of variable stiffness may be created with the aim of concentrating/amplifying the displacement/strain at the strain gauges for maximum effect.

Drill string threads routinely bind and become very difficult to undo. Often the operators have to impact the joint with a heavy implement, such as a hammer, whilst applying maximum reverse torque in order to loosen the joint between pipes or sub and pipe, which is not recommended as it may damage the components and can be hazardous for personnel.

Hydraulic ‘breakout’ spanners and foot clamps are often present on the drill rig, these devices having jaws that articulate radially and clamp on the cylindrical outer surface of the pipe. Often these however slip due to the high torque being used and worn grippers. When slippage occurs the outside diameter (OD) of the pipes is often heavily scored and damage accumulates with time, resulting in weaknesses and premature need to replace the components.

Additionally, oft-times the pipes, if not specifically selected for a particular drill rig, will not align with the breakout when the lower ends are engaged in the foot clamps (or similar restraining device) due to length issues, forcing the removal of several pipes simultaneously from the rig and use of a standalone breakout bench, if one is present.

Flat surfaces have previously been provided on an external surface of the pipe to enable fitment of a tool, such as a spanner/wrench, to mitigate these issues.

However, depth of the flats, if present, is normally limited due to the thin wall present, and even when they are present on such pipes tend to round off and become ineffective. Additionally, the high forces created during the process may plastically deform the tubular section of the pipe and render it unserviceable.

The aforementioned type of problem may be mitigated in respect of the one or more embodiments of the present invention having an internal flange and/or bulkhead proximal to (e.g. behind) the flats to provide structural reinforcement to prevent such damage.

The internal flange may be internal and optionally beneath or between diametrically opposed flats. It may be centrally located in the axial direction along the flats, or it may be biased toward or at one end of the flats. The internal flange may not necessarily be internally beneath the flats but may be axially displaced a short distance beyond them.

The housing may be manufactured from a solid bar or thick-walled blank, enabling substantial flats to be present that are not limited by the thin wall of standard tube stock. Stock hollow bar/tube may have a wall thickness of 20 mm or more, thus enabling very substantial flats to be machined on the outside of the tube whilst maintaining significant material beneath the flats.

Preferably the housing of one or more embodiments of the present invention includes further material below/under the flat(s) to further minimize localized deformation during use. The greater the wall thickness beneath the respective flat the greater the remaining strength and resistance to local deformation arising from the forces imposed on the flat e.g. by a spanner's reaction against the flat(s)

One or more forms of the present invention may include a communication means, such as a transceiver, remote transmitter, electronic gateway, network switch or other network device, and/or may provide signals to a communication means, such as a pulse e.g. a mud pulser, light emitter or Doppler device.

One or more forms of the present invention may include the communication means to communicate with a device downhole (such as a downhole geophysics sensing device, probe, orientation device).

The communication means may be mounted, such as embedded, internally of the housing, preferably just below its outer surface.

The communication means may provide data relating to the drilling operation. Data may be communicated in real time or near real time, or may be recorded and provided subsequently, such as when the apparatus is retrieved and/or interrogated or is prompted to provide data or reaches a threshold point, such as storing a certain amount or type of data or is at a particular location.

Preferably the data is provided in real time or near real time, enabling rapid analysis of drill data and optimization of the drilling process.

Preferably the communications means transmits/receives data through an electromagnetically (EM) transparent window of the housing. Preferably the window includes a non-metallic, EM transmitting material.

EM transparent windows help to ensure long range reception, such as RF transmission protocol, WiFi, Bluetooth etc., reduce the likelihood of transmission errors, allow for live streaming of data (the apparatus can run on its own and store data and/or it can be an internet of things (IOT) apparatus sending data to the cloud.an IOT device to the cloud.

The apparatus can detect that one or more sensors is measuring out of/over threshold or beyond a safe operating point/level. For example, the apparatus can determine that torque is above or trending to be above a threshold. Time stamp of events can be triggered by the apparatus, such as sensed values being above a respective threshold. Events can be unusual issues (excursion)—such as sensed values being out of bounds, out of preset limits when thresholds are crossed etc. Such an event can be alerted by transmission to a remote monitoring location.

The apparatus can include on-board processing for processing of sensed values/data, or can send the values/data externally for processing.

One or more forms of said communications may be by way of an EM communications arrangement as described and set out in international PCT publication WO 2013/023245, the contents of which are incorporated herein by reference. In particular, communication may be by way of an EM transmission device that transfers at least one EM signal to and/or from the apparatus, the EM transmission device preferably having an EM signal direction altering means. The signal direction altering means may include a reflector. The EM signals may be optical, infra-red or radio wavelength/frequency or other EM spectrum signals, or a combination of two or more different frequencies/wavelengths of EM signal.

The housing may include an internal recess or cavity to hold the communications means or at least an antenna thereof. A transceiver unit may be mounted on a support attached to the inner tube and/or an end cap.

An integrated antenna eliminates the need to create further features needed to package and protect this item as well.

A GPS device, transceiver and/or antenna (e.g. a flat aerial) may each be generally square or rectangular devices in plan-view. Although each of these could be mounted in a circular cavity, either substantial material would need to be removed and a greater strength loss than if rectangular cavities were formed, or circular cavities would need to be of larger diameter to accommodate the ‘corners’ of the device(s).

However when subjected to torsion, the use of four sided/rectangular cavities causes a geometric stress raiser that results in an increase in tensile stresses in one pair of opposing corners, thereby limiting the strength of the device.

To mitigate this it is necessary to use generous radii at the corners of the cavity, the purpose of which is to create a more gradual change in material section reduce the degree of stress concentration when compared with a sharp vertex.

The actual stress level is very sensitive to the radius of curvature used in the corners and therefore to the respective cavity has been optimised.

Similarly the edges of the flats have geometry optimisation for an analogous reason.

Preferably, locating the transceiver unit remote from electronics of the apparatus can eliminate need to route a shielded co-axial cable between the transceiver and the separate antenna in the recess/cavity. Consequently, preferably the transceiver unit is mounted with the antenna in the recess/cavity internally of the housing.

Having the transceiver mounted with an electronics unit i.e. centrally rather than mounted to the housing presents a challenge as the interconnecting co-axial cable is relatively rigid and large in diameter for the available space, and therefore difficult to route within the space available. Additionally, the necessarily miniature co-axial connectors (such as UFL connectors) are not self-aligning, are fragile and prone to damage when connections are made.

Furthermore, due to the compact design of embodiments of the present invention, all electrical connections within the housing become inaccessible during the assembly process. Consequently, one or more embodiments of the present invention utilises wireless communication between the transceiver mounted to the inside wall of the housing to data processing electronics supported adjacent the conduit.

One or more embodiments of the present invention has an onboard global positioning system (GPS) module, thereby providing accurate (e.g. UTC) time stamping of all data, preferably one or both of both streamed and logged data, and/or preferably automatic recording of location and/or collar location (such as to identify that drilling is at an expected geographical site. This can be useful for tagging data sets to help monitor geographically where the data comes from, for data integrity).

In both instances, for the communication means and the GPS module, the respect recess/cavities created for each of these items can be placed in line with the aforementioned internal bulkhead which thereby provided both strength compensation for the recess/cavity and the necessary material available to incorporate the recess/cavity.

The internal bulkhead may be sufficiently thick in the axial direction, effectively providing solid material in which one or both of the cavities may be formed. One or more additional internal bulkheads may be provided towards or at each end of the apparatus, thereby providing separation of internal cavities from pressurised drill fluid.

The housing of one or more embodiments preferably includes an extension portion, which may at least partially house a charge storage module, such as one or more batteries/capacitors and/or may function as a replaceable saver/adapter sub.

For example, for economic reasons it can be worthwhile providing the extension as a sacrificial ‘saver’ sub, as this item is subjected to the thread wear arising from many rod changes. It is not desirable to subject the high cost instrumented apparatus containing electronics and transducers to this wear which would otherwise force it to undergo frequent major rebuilds or be an expensive discarded product.

The extension/saver sub may be provided with one or more threads at the end distal from the load cell/device to thereby enable the device to be connected to different types and sizes of drill rod.

The extension/saver sub may possess a thicker bulkhead/wall than that of the drill rods, thereby enabling the incorporation of the one or more flats for the fitment of spanners/wrenches or other tools to ease removal, rather than relying on problematic cylindrical external clamps as previously described.

An inner bulkhead for the extension/saver sub need not be required adjacent to the internal bulkhead due to the significantly greater wall thickness that can be provided compared to that of the housing.

One or more embodiments of the present invention provides separate compartments for electronics (such as a processor, strain gauges, power management electronics) and the charge storage (batteries, capacitors).

Preferably, the compartments are divided by at least one housing internal bulkhead. Thus, the sensitive electronic components and sensors are not disturbed when changing the charge storage (batteries etc.) and the apparatus is inherently more reliable.

Preferably, one or more forms of the present invention includes a charging port for recharging the charge storage. For example, if using rechargeable batteries, there is no need to remove them as they may be charged in situ.

Also, because embodiments of the present invention can be relatively small and light, and easily changed on the rig, as well as being of relatively low cost, it is feasible to have a fully charged apparatus on standby, again eliminating the need to swap charge storage (batteries etc.) when they have expired.

The cavities at each end of the apparatus may be considerably shallower than that of a single cavity holding electronics and charge storage (batteries etc.), and as a result are more readily machined during manufacture of the housing.

Preferably, one or more forms of the present invention includes at least one pressure sensor. The at least one pressure sensor may be provided to measure the pressure of the drill mud during operation. This enables determination of one or more modes of operation of the drill rig, such as idle (not drilling), drilling, sharpening of the bit, confirmation of changing rods, and more.

At least one pressure sensor 52 may be provided at an end cap of the apparatus.

The end cap 26 has a conduit 27a therethrough to the inner tube 14a. The opposite end cap 24 has a conduit 27b therethrough to the inner tube 14b. The two inner tubes connect, either directly to each other or to an intermediate tube. The inner tubes provide a continuous conduit through the housing for fluid (such as drilling mud) to flow. The conduit 27a, 27b can have a tapered entry/exit surface 27c to aid smooth fluid flow and reduce abrasive wear at the entry and exit to the inner tube.

The at least one pressure sensor 52, particularly if provided at a said end cap, can be used to monitor the pressure of the drilling mud. This enables one to know if the mud flow stops, fluctuates, or not (e,g, no pressure of pressure fluctuation indicates reduced or intermittent flow).

Also, if pumping a core barrel into the drill/bore hole, the at least one pressure sensor can detect a pressure spike produced when the core barrel lands ‘home’ on its landing ring, informing the driller the barrel is correctly positioned and enabling commencement of drilling with confidence.

Sensing/measurement of flow through the apparatus can be used to monitor and/or control drilling operations.

For example, as a drill bit wears (particularly a diamond tipped drill bit), drilling performance decreases. To help sharpen (strip or polish) the drill bit (particularly in the case of diamond tipped drill bits), fluid flow can be reduced and/or WOB can be increased and/or higher torque/RPM can be applied to the drill bit. This can cause sharpening/stripping/polishing of the drill bit e.g. to expose fresh diamond layers. Fluid flow can then be increased, WOB can be decreased and/or RPM/torque can be decreased to optimise drilling progress again. Pressure may also or otherwise be sensed and used to determine whether or not to strip or polish the drill bit.

One or more embodiments of the present invention may include at least one turbine placed in the fluid flow, preferably provided in or adjacent to the flow path through the inner tube or a reduced diameter mud tube that passes through the apparatus.

At such a location velocity of the fluid flow is increased due to the reduced diameter flow path, and it is possible to harvest some of the kinetic energy of the fluid and convert that kinetic energy to electrical energy, such as via the placement of suitable magnets and wound coils associated with a turbine/impellor driven generator. The turbine may or may not be positive displacement.

One or more embodiments of the present invention includes at least one flow meter to measure the flow (volume, rate) passing through the inner tube.

Flow measurement can provide similar information to that of the pressure sensor(s) mentioned previously; however, flow measurement is more direct and enables other drilling conditions to be detected or deduced.

The aforementioned power harvesting turbine may be used also as the flow meter, with the flow being a function of the RPM of the turbine and the frequency of the electrical pulse produced by the coil.

Preferably, one or more visual indicators, such as LED lights, may be provided to be visible through or on an external side wall of the housing. For example, a recess may be provided in an outer surface (e.g. side wall surface) of the housing, which can allow for status of the device to be seen by an operator, such as when the apparatus is mounted in a drill string at the surface.

One or more visual indicators may be provided at a computer, operator terminal or other site, which may be distant from drilling site.

The one or more visual indicators may provide operational mode status of the apparatus, fault status (e.g. a different pattern or flash rate of light indicators), communication status e.g. signal strength, can be infrared communication to a one or more lights rather than via computer.

Preferably, for a surface (aboveground) application of the present invention, the apparatus can be provided between a head drive spindle (or the chuck driven ‘Kelly’ rod) and the uppermost drill rod. In this location, the drill rod needs to preferentially undo/release whenever reverse torque is applied rather than at the joint at the present invention. Means of achieving this is to adopt a finer thread on the outer housing of one or more embodiments of the present invention than that used one the drill rod, as the reduction in helix angle at the thread mating faces locks them more tightly together for a given torque than a coarser variant. Therefore, preferably embodiments of the present invention may be provided with a 4 TPI thread rather than the standard 3 TPI thread used on drill rods.

Wall thickness of the finer thread can preferably be increased in both the box (female) and pin (male) joints to compensate for the increase in stress that arises.

Additionally, the stress has thereby been reduced at the threads, such that at maximum rated load for the drill string it remains below the endurance strength (life >10⁷ cycles) for the material thus minimising the risk of failure via fatigue.

The apparatus may include a device for determining azimuth of the apparatus. Azimuth may be determined by a device including a north seeking gyroscope.

The apparatus/device may be provided axially in-line in a drill string, preferably provided in a drill string adjacent or towards a chuck or top drive of a drill rig.

The apparatus may include at least one light and/or audible indicator, preferably on the device or provided remotely. The at least one light and/or audible indicator may be provided around a periphery of the device. The at least one light and/or audible indicator may be annular or spaced around the periphery of the device.

The apparatus may include at least one collar mounted externally of the housing.

### BRIEF DESCRIPTION OF THE DRAWINGS

Further advantages of the present invention will emerge from the following description of one or more preferred embodiment(s) of the present invention, given with reference to the accompanying drawing figures, in which:

FIGS. 1A and 1B show diagrammatic/schematic layouts of components for a drill string incorporating an embodiment of the present invention.

FIG. 2 shows a perspective internal view of an apparatus according to an embodiment of the present invention.

FIG. 3 shows electronics arranged to be mounted internally of an external housing according to an embodiment of the present invention.

FIG. 4 shows an exploded view of an apparatus according to an embodiment of the present invention.

FIGS. 5A and 5B show electrical charge storage means according to an embodiment of the present invention.

FIG. 6 shows detail of a portion of the apparatus with locating plate within the housing according to an embodiment of the present invention.

FIG. 7 shows internal arrangement of components of an embodiment of the present invention.

FIG. 8 shows internal arrangement of components of an alternative embodiment of the present invention with power generation from harvesting energy from fluid flow and/or sensing fluid flow.

FIG. 9 shows an instrumented internal conduit with strain gauges on an external wall of the internal conduit for the apparatus according to an embodiment of the present invention.

FIGS. 10A and 10B show features of external collars according to a further embodiment of the present invention.

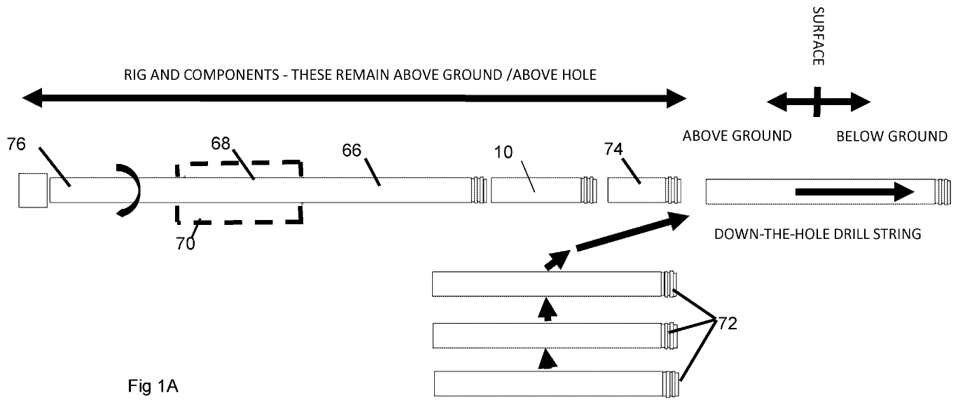

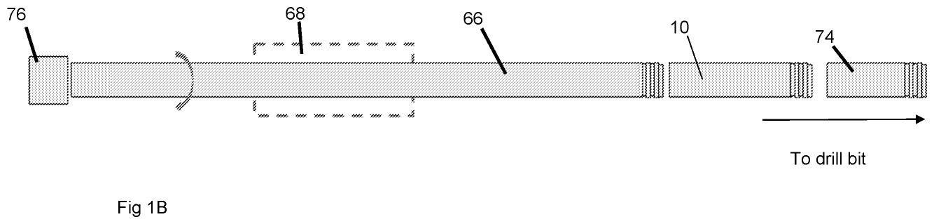

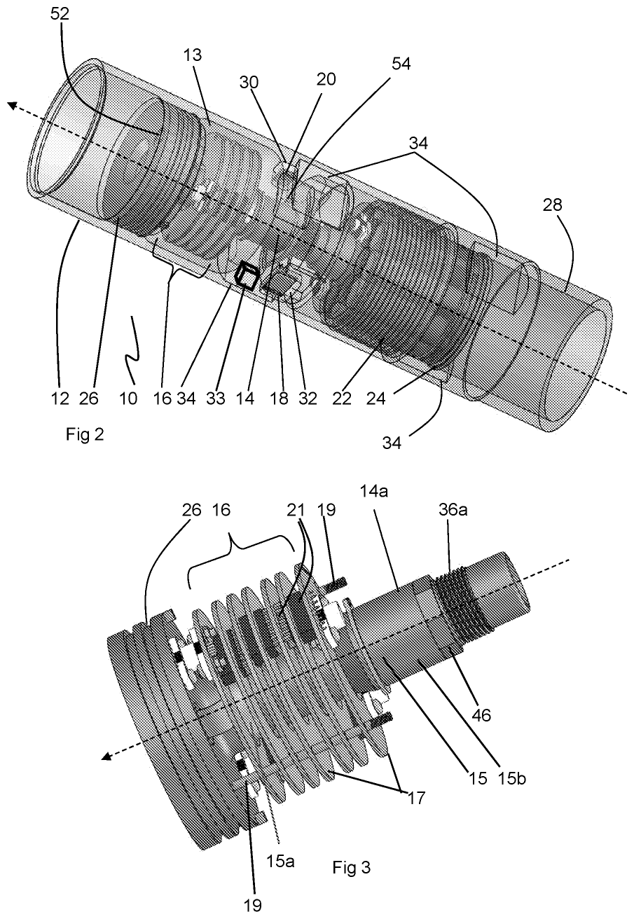

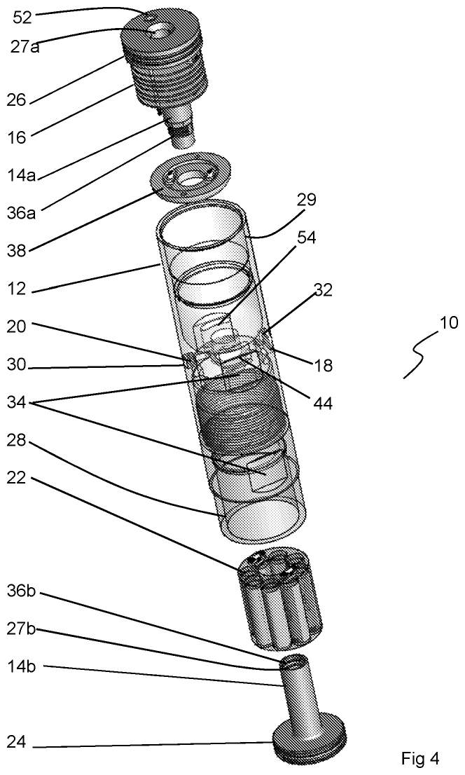

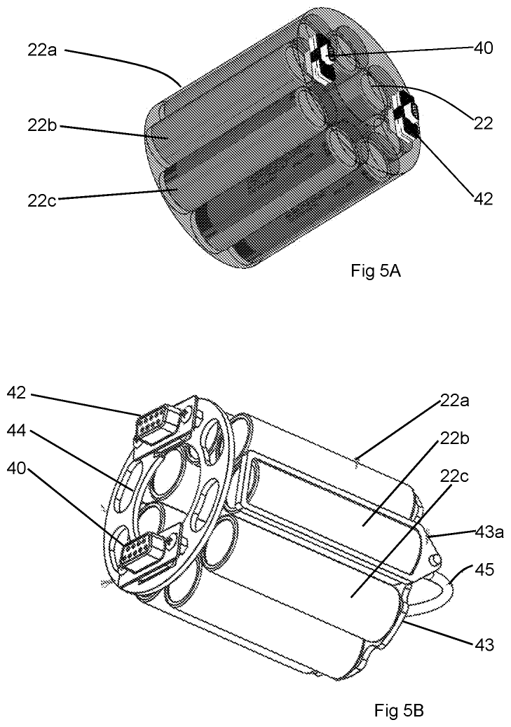

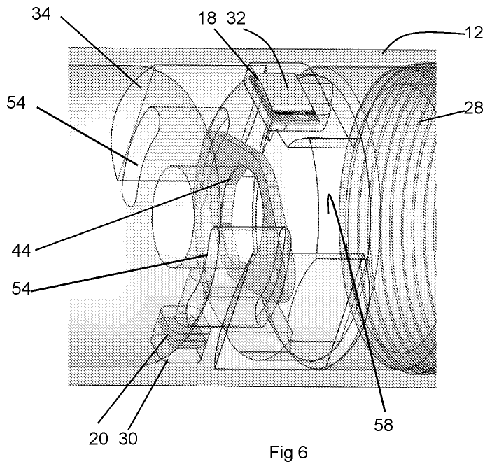

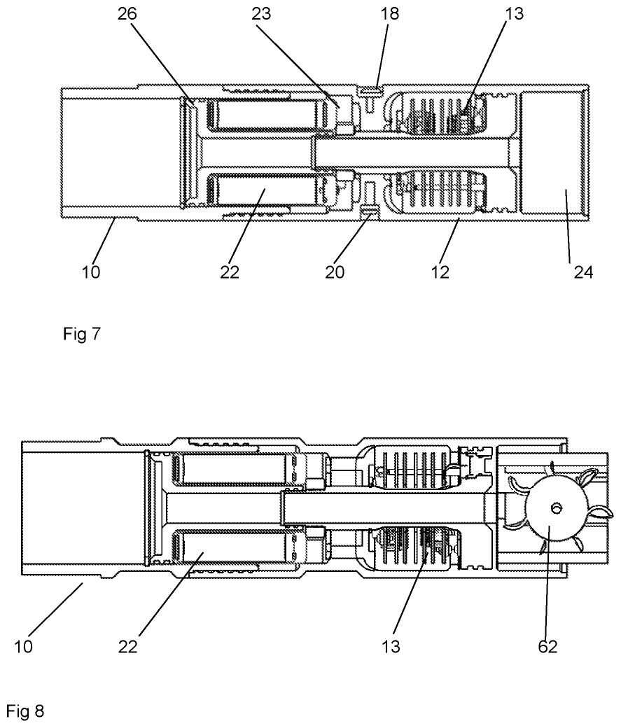

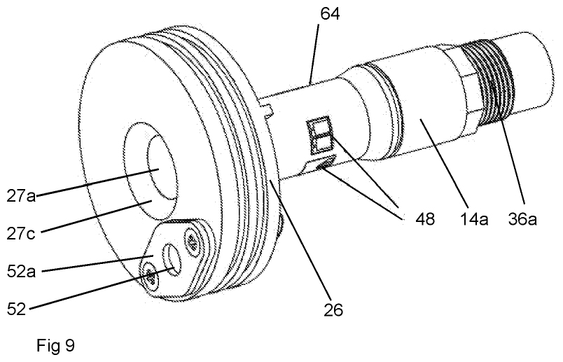

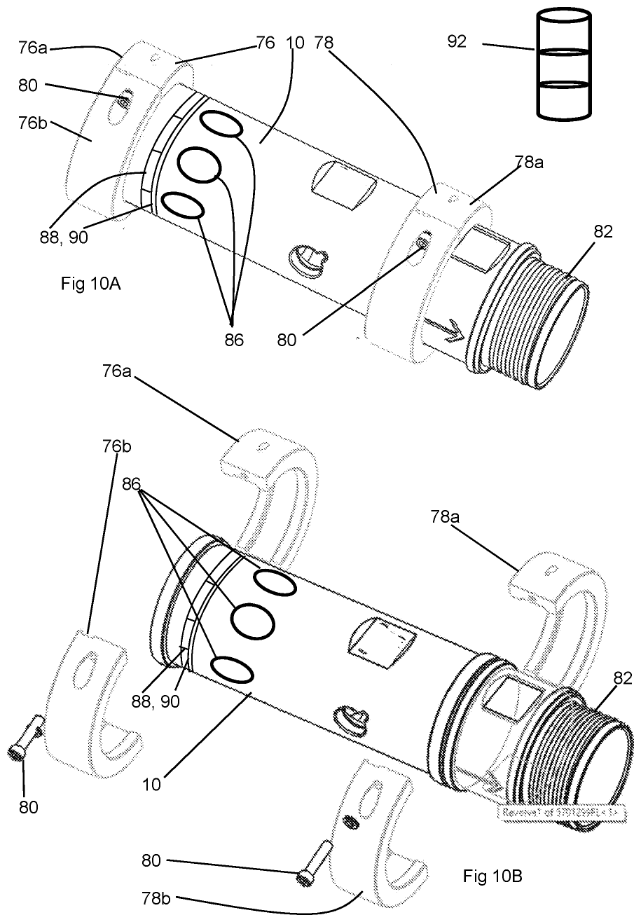

### DESCRIPTION OF PREFERRED EMBODIMENT

In the following detailed description, reference is made to accompanying drawings which form a part of the detailed description. The illustrative embodiments described in the detailed description, depicted in the drawings and defined in the claims, are not intended to be limiting. Other embodiments may be utilised and other changes may be made without departing from the spirit or scope of the subject matter presented.

It will be readily understood that the aspects of the present disclosure, as generally described herein and illustrated in the drawings can be arranged, substituted, combined, separated and designed in a wide variety of different configurations, all of which are contemplated in this disclosure.

As shown with reference to the Figures, an apparatus 10 embodying the present invention provides a housing 12 within which resides an instrumented device 13 and an inner tube 14 providing a flow path through the apparatus.

The apparatus can be connected axially in-line with a rod 66 of a drill string, such as a Kelly rod. A chuck 68 of a drill rig head 70 retains the rod during drilling operations. It will be appreciated therefore that the apparatus of the present invention being axially in-line with the drill rods can provide an accurate measure of direction to drill, such as azimuth, dip/inclination. Such measurement can be particularly useful at commencement of drilling to direct the drill hole in a required direction from a required location.

A saver sub 74 can be provided, such as in-line between the apparatus 10 and drill rods 72. A saver sub is a short piece of connecting pipe with threads on both ends, which is part of a drill string.

A swivel 76 can be provided to rotatably support/connect the drill string to a drive of the drill rig. The swivel can include a water connection for supply of water to the drill string.

The inner tube provides the flow path for fluid (such as air, water, drilling mud, or combinations of two or more thereof) to flow through the apparatus during a drilling operation.

It will be appreciated that the term ‘inner tube” is not intended to limit embodiments of the present invention to a simple straight walled circular section tube; rather, the term inner tube defines a flow path for fluid to flow through the apparatus.

In one or more embodiments, the inner tube can be a tube with relatively smooth bore internal wall of circular cross section. A straight bore inner tube is preferred in some instances, such as when the fluid is viscous or difficult to pump, or contains contaminants that might otherwise clog a more convoluted or separated flow pathway through the apparatus.

The instrumented device 13 includes electronics 16, such as for signal/data processing, storage and management, a Wi-Fi transceiver 18, a GPS module 20 and a charge storage device 22 (such as one or more batteries and/or capacitors) for powering the electronics.

The charge storage device 22 can include a a ring/annulus of battery cells 22a . . . n, the charge storage device 22 receives through the centre thereof the inner tube 14b.

Preferably the electronics 16 may be provided as an electronics module and the charge storage provided as a power module, the electronics module and the power module being receivable into the housing 12 from respective opposed ends of the housing.

The electronics module and/or the power module may each be provided around a respective portion of the inner tube. Separate portions 14a, 14b of the inner tube may have threaded sealing engagement with each other such that when each module is inserted into the housing, relative rotation of the inner tube portions connects the portions and seals the flow path.

One or other of the inner tube portions may include engagement portions for engaging with locating portions attached to the housing, such as on a locating plate 44. Thus, one of the modules may be fixedly located with respect to the housing while the other module can be rotated relative to the housing to connect and seal together the inner tube portions within the housing.

The housing may include one or more external flats 34 for engagement with a spanner or wrench to help rotate or prevent rotation of the housing when tightening the apparatus to a drill string or breaking the apparatus from a drill string, or when assembling and/or disassembling the internal electronics and/or power modules to/from the housing.

At least one strain gauge 48, preferably multiple strain gauges, is provided on the outer surface of the inner tube and connected to the electronics module. Torque and axial force are measured via strain gauged inner tube.

Force/load measurement can be provided through the inner tube and at least one associated bulkhead 54, preferably multiple bulkheads.

It will be appreciated that the bulkhead(s) transfers forces/loads from the external housing to the inner tube to be detected by the strain gauge(s). This provides for measurement of force and torque in parallel with the main outer stressed housing.

The transducer (strain gauge(s) and associated electronics) can be calibrated with lower forces than required otherwise. Also, because the strain gauge(s) is mounted to the outer surface of the inner tube, calibration, testing and maintenance can be done directly to the electronics module with the strain gauge(s) bonded to the inner tube before assembly into the housing.

It will be appreciated that the strain gauged inner tube transmits only a small portion of the load, the bulk of the load being taken by the non-instrumented outer member/tube, only a fraction of the force is required for calibration. As an example if apparatus senses only 5% of the total load, if a maximum load of, for example, 20 tonnes were present the strain gauged inner tube would only see a load of 1 tonne (5%). Hence, the inner tube can be calibrate with a maximum load of 1 tonne, thereby requiring much smaller equipment that is inherently safer for the operator due to the lower load.

Flow sensing of fluid flowing through the inner tube can be provided by one or more flow sensors 50. Flow sensing may measure fluid flow velocity (m/s) and/or fluid flow volume rate (m³/s).

Fluid flow differential (measured at two or more different points) may be provided. For example, measuring fluid flow at an inlet to the flow path and at an outlet to the flow path through the apparatus.

Fluid flow may be measured by at least one impellor rotating (speed and/or rate), magnetic device (e.g. cutting lines of flux or detecting ions/movement of ions in fluid flow) and/or Doppler device.

Pressure may be sensed by at least one pressure sensor 52.

Two or more pressure sensors may be employed to sense pressure differential between an inlet side and an outlet side of the apparatus. Pressure differential (Δp) between the inlet and outlet, or any two longitudinally separated points within the borehole, may be employed to determine depth within the borehole or drilling progress or efficiency (e.g. rate of fluid flow).

Preferably, at least one on-board pressure sensor 52 may be employed to sense or measure hoop stress compensation for strain measurement.

The apparatus 10 may include one or more accelerometers 56, such as to detect vibration, angular movement and/or position, or longitudinal and/or position movement (with respect to the borehole). Preferably a triaxial (x, y, z coordinate) accelerometers is provided.

Vibration may be detected by accelerometers provided in the apparatus. Also, energy harvesting through capture of kinetic energy from vibration, (e.g. by electromagnetic induction or piezoelectric device), may be used to power the device and/or recharge the energy storage.

Revolutions per minute (RPM) of the apparatus (and therefore the drill string) may be sensed. For example, the accelerometers may be employed to sense RPM via centripetal acceleration.

Gravity vector component (e.g. frequency) may be detected by a rotational vector sensor. The gravity vector component may be detected with the accelerometers and its frequency used to determine rotational speed for all instances, with the exception of for vertical holes. For vertical holes measurement of centripetal acceleration is utilised. Accelerometers may be utilised to detect roll angle.

The apparatus can preferably internally self-calibrate centripetal acceleration/RPM against gravity vector frequency at any time except when drilling vertical holes. This ability provides a high confidence level in the centripetal acceleration determined RPM which otherwise may not have been the case.

Rate of penetration (ROP) may be derived from signals from the accelerometers, gyroscope(s) and/or change in depth and/or pressure measurement (such as progress from a reference at the top of the hole or change of pressure downhole). Weight on bit (WOB) may be sensed by the strain gauge(s).

The apparatus 10 may include a device 33 to measure azimuth, such as a north seeking gyroscope.

When the axis of a gyroscope is parallel to the Earth's spin axis, the gyroscope will be stable. However, if the axis of the gyroscope is not so aligned, the gyroscope will precess. Precession is a change in the orientation of the rotational axis of a rotating body, such as a gyroscope. Therefore, the gyroscope can be used to determine a direction (angle) to North to high precision.

It will be appreciated that the charge storage device (such as batteries/capacitors) can be replaced or checked whenever assembling or disassembling the apparatus into/from a drill string e.g. at drill string rod change) or before/after supply to drill site.

The extension 28, 29 to the housing end provides for a ‘saver’ portion by which the internal electronics and power modules are protected from damaged if the end of the housing becomes damaged. Only the outer housing 12 needs replacement.

The communication means 18 (such as a Wi Fi transceiver) and/or GPS device 20 can respectively be mounted to an internal facing recess or cavity of the housing 12. Antenna for each may communicate through an EM transparent window 30, 32. The EM transparent window may be of fibre-glass or polycarbonate or other non-metallic material of suitable strength and wear characteristics.

The material of the EM transparent window may include or be non-metallic, and may be a high strength polymer such as polycarbonate, or a tough material such as acetal, or an epoxy, or possibly a composite fibre material such as GRP or other, or a combination of two or more thereof.

Connection can be made by cable from the respective communications means and/or GPS to the electronics module and/or the power module. Having the communications means and/or the GPS module mounted to the internal recess/cavity in the inside wall of the housing avoids the need for relatively large and inflexible coaxial cables from respective board mounted communications/GPS modules to an antenna. Embedded (nub) antennae provide for space and performance (packaging) optimisation. Preferably, the antenna/antennae are smaller than a spanner flat of the apparatus, and therefore the respective antenna can be embedded/bonded beneath the spanner flat. The spanner is larger than the antenna but smaller than the spanner flat so spanner cannot transfer any reaction to the antenna. Also it cannot ‘stab’ the antenna because it is too wide. An alternative is a small wire ‘nub’ aerial that comprises a short single wire, whereby, packaging wise these are more convenient, however there are performance compromises with this type of aerial/antenna.

The inner tube can include a shaft 15 that varies in width/diameter along a length thereof. For example, the shaft 15 may be narrower in outside width/diameter (OD) where the at least one strain gauge is mounted to the shaft, and be wider/of greater outside diameter (OD) away from the at least one strain gauge. Such narrowing in width/diameter at the strain gauge(s) can be selected to vary, as required, the stiffness of the shaft of the inner tube to amplify strain and resolution from forces/load from the outer housing. It will be appreciated that the inner tube shaft 15 can be a shaft portion of a tube section of the inner tube.

Preferably, one or both ends of the device (electronics and power modules) within the housing can be connected together and connected to at least one n load transfer portion within the housing, such as a bulkhead, shoulder, plate, locking means etc. That is, a firm connection is provided between the device within the housing and the housing, to transfer forces/loads to the at least one strain gauge on the inner tube in parallel from outer housing.

Preferably the apparatus includes at least one flexible connection between sections of electronics to mitigate torque wind-up fatigue of electronics connections. For example, sections of electronics (e.g. power management, digital processing, data storage, digital to analogue conversion etc.) can be mounted on separate supports 17 spaced from each other. Supports can be plate like, preferably disc like, spaced along the inner tube within the housing. Flexible electrical/optical connections can be coupled between the electronics on said plates/discs to avoid transferring vibrations between electronics sections and maintain reliability and accuracy in the field.

Preferably, one or more aligners/locators 19 can be provided to ensure correct alignment of one support 17 relative to the next. This can assist in ensuring that connectors 21 between supports 17 align and connect correctly. The aligners/locators 19 can be positioned such that the supports only align one way to ensure correct positioning and avoids assembly error(s).

Pressure sensor decoupling may be provided to prevent crevice corrosion e.g. damage by corrosive drilling mud. For example, a pressure sensor may be mounted in one of the bulkheads located at either end of the apparatus, e.g. the bulkhead forming one end of either the electronics enclosure or the battery enclosure. One side of the respective bulkhead is therefore exposed to the pressurised drill mud (up to 2000 psi typically), whilst the opposing side provides access to the electronics compartment at ambient pressure (˜1 bar abs.) The sensitive pressure sensor face can be protected from the corrosive drill mud (0<pH<10) by an intermediate chamber containing a fluid to transmit hydrostatic pressure to the sensor. The fluid may be an oil or similar non-electrolytic fluid. The intermediate chamber may be separated from the drill mud by a movable barrier such as a diaphragm or slidable piston e.g. to enable near lossless hydrostatic pressure transmission to the fluid.

A thread 82 at one or each of the ends of the apparatus for connecting the apparatus into a drill string may have a thicker thread wall than standard drill pipe in order to eliminate fatigue. Wireline type drill rods can range from 55 mm outside diameter (OD) to 114 mm OD and have a wall thickness between 5 and 6 mm. The height of a typical rod thread is of the order of 1/16″ (1.6 mm), and since the rod thread mean diameter is close to the middle of the wall by definition the wall thickness remaining at the thread root (the minimum wall thickness remaining that is) is approx. (½×5)−(½×1.6)˜1.8 mm thick. The minimum wall thickness that will be used on the apparatus in order to provide long life (i.e. minimal fatigue risk) may be more than double this, so >3.2 mm typically.

For example, the apparatus may have a coarser thread 82 for connection to a drill pipe than the drill pipe has, thereby reducing the risk of accidental break-out of apparatus from the drill string.

Use of stacked annular printed circuit assemblies (PCAs) and shields to optimize packaging, mitigate electromagnetic interference (EMI).

The electronic components are preferably soldered to the PCAs. In embodiments, the PCAs are circular to fit the inside diameter of the housing. They are screened from each other to prevent EM cross talk from one circuit to another.

A floating connector plate can be provided for mating connectors for the PCAs for torque displacement compensation.

Use of plug together modules for assembly purposes, otherwise it is inaccessible

One or more reinforcements, such as one or more bulkheads, can be provided within the housing, such as under the flat areas for engagement with a spanner/wrench. Such reinforcement(s) help to strengthen the housing where the side wall thickness of the housing at the flats may otherwise be reduced due to the inset nature of the flats relative to the curved outer surface of the housing.

Separation/isolation of electronics of the electronics module from the charge storage can be provided. For example, a barrier sealing a charge storage device space from an electronics module space may be provided. Such a barrier may include a wall, which may extend across the internal side wall of the housing to at least partially compartmentalise the electronics from the charge storage. Such a barrier may include an aperture for the inner tube to pass therethrough. One or more seals can be provided between the inner tube and the barrier and/or between the barrier and the housing side wall. Separating/isolating the electronics from the charge storage device helps to avoid contamination of the electronics during charge storage device replacement, such as battery replacement or charging.

One or more embodiments of the present invention can include at least one of a vibration detector and/or a sound detector. Sound detection may be provided by at least one microphone 60. The microphone may be mounted internally of the apparatus, with sound being transmitted though the sub housing wall. Airborne noise will be transmitted through the metalwork to the microphone.

Sound detection can be used to detect arrival of a downhole instrument or tool, such as an apparatus of the present invention, at a desired downhole location. For example, landing of a coring inner tube (with the apparatus of the present invention directly or indirectly connected thereto) downhole. Sound detection may be used to monitor/detect drilling progress/correct drilling.

Audio and/or visual indication may be provided to a computer, to a user/operator terminal and/or to one or more personnel at the surface, such as a drill operator. Such indication may be provided to inform (e.g. inform personnel) that an action is complete or a threshold has been met i.e. an over torque warning, wind up of the drill string, rate of penetration (ROP) falling below or above a respective threshold, fluid pressure increase or decrease, or other downhole event that has been identified.

Such indication can be provided by or augmented by one or more visual indications, such as by one or more lights. The lights (e.g. LEDs) may be embedded below the outer surface of the apparatus, and may be protected by a transparent/translucent barrier. The one or more lights may be provided external to, preferably mounted to, the housing e.g. mounted on a side wall.

A visual and/or audible indication may be provided from a lighting 88 and/or sound 90 arrangement. For example, the device may include one or more annular lights or a number of spaced lights around an exterior thereof 88. Because the apparatus rotates with the drill string, light indication that are visible as the apparatus rotates can be beneficial to operators.

Alternatively or in addition, the device may communicate to at least one remote lighting/audible arrangement 92. For example, a stacked light system to which the apparatus communicates will pick up the signal transmitted from the apparatus and display a required indication—such as RED—something not right, Amber—alert, Green—all is well. Audible alerts can be transmitted to match the light indications i.e. different pitches of sound and/or rate of intermittent sound.

At least one camera 86 can be provided for a visual recording. The camera(s) can be provided on the device 10, e.g. in the housing. The camera(s) can be synchronised to capture images/video so that the images are still or movie images during the rotation of the device e.g. a steady picture and the device can view the work area for monitoring and safety.

One or more embodiments of the present invention includes apparatus/methodology for user/personnel to take action if a set of conditions are met. For example, if a drill bit needs sharpening or vibration is too much to raise the RPM. The drilling operator/personnel can be provided with a display/view of settings and current drilling parameters/values (RPM, WOB, torque, ROP etc.), threshold settings, chart of sensor output vs time and configuration control, event logger etc. This may show drilling events against time and/or depth.

Data storage can be provided to store raw drilling data, a log of real time drilling events. A report generator can provide a report of drilling events and progress.

Voice/audible prompts may be provided to users/personnel, such as over threshold detection to earphone audio, and visual indications may be provided e.g. via lights indicators.

One or more algorithms may determine that action needs to be taken or a warning needs to be given, such as to increase or decrease RPM, WOB, fluid flow for flushing/cooling or to reduce vibration.

A carrier 43 for connectors can be provided that provides mechanical strength to the annular charge storage device/battery pack 22.

Stirrups 43a provide axial anchorage for an extraction handle/loop 45

A coarser thread 82 (rather than finer thread) to connect the apparatus to tube components of the drill string (such as drill rods, saver tube, Kelly rod) is preferred. An internal thread (not shown) can be provided at the opposite end.

Such thread can be provided in conjunction with lock collars 76, 78 (76a, 76b, 78a, 78b) to ensure easy break-out when disconnecting the apparatus from the drillstring. Lock collar halves 76a, 76b and 78a, 78b can be retained together by fasteners 80. The fasteners 80 can be released for separation of the halves for removal of the collars.

It can be necessary for the sub to remain attached in the drill string and adjacent to the drill head so that the drilling forces of the head are transmitted through it to the rest of the drill string. It is further preferred that whenever the driller adds or removes drill rods to the drill string, the rod threaded joints ‘break’ at a lower torque than the joint/s attaching the sub to the drill head, as the sub must remain firmly attached as an integral part of the drill head. To achieve this, a finer pitch can be used on the necessary joints on the sub so that for a given torque these would lock more tightly than the standard rod threads used. This works very effectively, however, it can be difficult to remove the sub itself from the head and the rig when necessary. Often the forces required to unthread the sub are so high that damage occurs to it, and in extreme case it may need to be cut off. This is clearly undesirable and threatens the viability of the device.

An alternative uses a thread with a similar thread and pitch as the drill string so that it can be more easily removed, and coupled with this incorporate a separate locking feature (rather than just the thread itself) to ensure it remains firmly coupled during normal operation.

One means of achieving this is to provide a flange proximal to each mating thread shoulder, to which a split collar 76a, 76b, 78a, 78b may in turn be fitted. The split collar thus locks the two adjacent flanges 84 together independent of the threaded joint, preventing the thread from unscrewing when torque is applied. The split collar would in turn be held in place by suitable means such as screws or clips or pins or suchlike.

Preferably the contact faces between the collar 76, 78 and flanges 84 are nearly orthogonal to the drill string axis so that the radial force component produced by the axial force arising from attempted unscrewing of the thread was minimal.

A charge storage device/battery pack 22 may be annular within the housing and around the central inner tube 14. For robustness, the cells, connectors and circuitry can be encased within an elastomer as this provided advantages such as mechanical compliance and shock resistance, sealing from the environment, and electrical isolation.

For increased strength, an annular metal carrier 44 can be incorporated at one end, which can also mount the connectors 40, 42 so that they do not rely on bond adhesion with the elastomer to remain in place and resist disconnection forces. This carrier can also be used to mount the protection and condition monitoring circuitry for the battery pack.

The battery pack can include a feature to enable the pack to be extracted from a blind cavity of the apparatus. A handle can be provided at the end distal from the connectors.

A mechanical link between the handle with distal end of the battery pack can ensure integrity. To achieve this, diametrically opposed stirrups can be provided fitted to several of the battery cells, with the base of the cell engaging the lower end of the stirrup, and the handle engaging the upper end.

The arrangement of the EM/RF transparent window and the communication means/module enabled the communication board/module to be rotated and thereby the antenna/aerial could be located both near the centre of the cylindrical cavity and close to the outer surface of the housing. This maximises the distance between the metalwork and the receive/transmit aerial and thereby optimises signal transmission/reception performance.

This configuration also enabled use of the chip antenna/aerial and avoid the need for larger patch aerials that are bulky within the space available. It also enabled the use of a commercial certified antenna/aerial and eliminated the need to go through the approvals process required of a non-standard aerial thereby saving both time and expense.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art is referred to herein, such reference does not constitute an admission that the prior art forms a part of the common general knowledge in the art, in Australia or any other country.

REFERENCE NUMBER TABLE

| No. | Feature |
|---|---|
| 10 | Apparatus |
| 12 | Housing |
| 13 | instrumented device |
| 14 | Inner tube (14a, 14b) |
| 15 | Inner tube shaft |
| 15a | Inner tube shaft narrow portion |
| 15b | Inner tube shaft wider portion |
| 16 | Electronics module(s) |
| 17 | Support plates/discs |
| 18 | Wifi transceiver |
| 19 | Guides/locators |
| 20 | GPS |
| 21 | Connectors |
| 22 | Charge storage (batteries, capacitors) |
| 23 | Internal bulkhead |
| 24 | End cap |
| 26 | End cap |
| 27a | Conduit from end cap to inner tube |
| 27b | Conduit from end cap to inner tube |
| 27c | Tapered surface to conduit exit/entry |
| 28 | Extension, saver sub |
| 29 | Extension, saver sub |
| 30 | GPS window |
| 32 | Wi-Fi window |
| 33 | Azimuth device |
| 34 | Flats |
| 36a | Inner tube thread |
| 36b | Inner tube thread |
| 38 | Bulkhead plate |
| 40 | Power connection |
| 42 | Power connection |
| 43 | Carrier |
| 44 | Locating plate |
| 45 | Handle |
| 46 | Engagement means |
| 48 | Strain gauge(s) |
| 50 | Flow sensor(s) |
| 52 | Pressure sensor(s) |
| 52a | Pressure sensor(s) housing/cover |
| 54 | Bulkhead(s) |
| 56 | Accelerometer(s) |
| 58 | Barrier |
| 60 | Microphone(s) |
| 62 | Rotary power generator (turbine) |
| 64 | Reduced diameter/width conduit |
| 66 | Rod of drill string/Kelly rod |
| 68 | Chuck |
| 70 | Drill head |
| 72 | Additional drill rods |
| 74 | Saver sub |
| 76 | 1^{st} Collar |
| 76a, 76b | 1^{st} Collar halves |
| 78 | 2^{nd} Collar |
| 78a, 78b | 2^{nd} Collar halves |
| 80 | Collar fasteners |
| 82 | Thread |
| 84 | Flange(s) |
| 86 | Camera(s) |
| 88 | Light(s) |
| 90 | Sound/speaker(s) |

1. An apparatus configured to be connected axially in-line in a drill string for measuring at least one parameter of a drilling operation, the apparatus including a housing, a conduit providing a fluid flow path through the housing, the conduit being connected to the housing at at least two spaced locations, and a device including electronics and at least one sensor, the at least one sensor being provided within the housing, wherein the at least one said sensor is provided on any one or more of:
an external wall of the conduit within the housing;
an internal face of a side wall of the housing; and;
an external face of a side wall of the housing,
and wherein the at least one said sensor includes at least one strain gauge.

2. (canceled)

3. (canceled)

4. (canceled)

5. The apparatus of claim 1, wherein at least one said sensor and electronics within the housing communicate wirelessly through the respective wall.

6. (canceled)

7. The apparatus of claim 1, wherein the conduit, includes a thinner walled section than one or more thicker walled sections with respect thereto.

8. The apparatus of claim 1, including a power generator to generate power to power electronics of the apparatus and/or to charge at least one charge storage device.

9. (canceled)

10. The apparatus of claim 8, wherein the power generator harvests kinetic energy from fluid flow through the device.

11. The apparatus of claim 1, including fluid flow sensing means for sensing fluid flow through the apparatus, including at least one flow meter to measure the flow (volume, rate) passing through the inner tube.

12. The apparatus of claim 11, including fluid flow sensing by at least one flow sensor arrangement by detecting inlet and outlet pressure differential, by Bernoulli effect of fluid flow through the apparatus and/or by sensing rotation of a turbine or power generator in the fluid flow.

13. The apparatus of claim 1, further including at least one pressure sensor.

14. The apparatus of claim 13, wherein the at least one pressure sensor senses a pressure impulse.

15. The apparatus of claim 1, wherein the conduit is directly or indirectly connected to the housing towards or at each end of the housing/apparatus.

16. (canceled)

17. The apparatus of claim 1, further include at least one flat surface on external surface of the pipe to enable fitment of a tool, and at least one an internal flange and/or bulkhead proximal to the respective flat(s) providing structural reinforcement.

18. The apparatus of claim 1, including a communication means and/or may provide signals to a communication means.

19. The apparatus of claim 18, further including at least one communication means to communicate with a device downhole, wherein the communication means is mounted or embedded internally of the housing.

20. (canceled)

21. The apparatus of claim 19, wherein the at least one communication means transmits/receives data through an electromagnetically (EM) transparent window through the housing.

22. The apparatus of claim 1, including separate compartments for electronics and charge storage.

23. The apparatus of claim 22, wherein the compartments are divided by at least one internal bulkhead.

24. (canceled)

25. The apparatus of claim 1, including one or more visual indicators provided to be visible through or on an external side wall of the housing.

26. The apparatus of claim 1, including a device for determining azimuth of the apparatus.

27. The apparatus of claim 26, wherein the azimuth is determined by a north seeking gyroscope.

28. (canceled)

29. The apparatus of claim 1, wherein the apparatus is provided in a drill string adjacent or towards a chuck or top drive of a drill rig.

30. The apparatus of claim 1, including at least one light and/or audible indicator, wherein the at least one light and/or audible indicator is any one or more of:
provided on the device;
provided remotely;
annular and provided around a periphery of the device.

31. (canceled)

32. (canceled)

33. The apparatus of claim 1, including at least one collar mounted externally of the housing.
